(19) United States
(12) Patent Application Publication
(10) Pub. No.: US 2011/0193468 A1
(43) Pub. Date: Aug. 11, 2011

(54) SPARK PLUG FOR A MODEL ENGINE

(76) Inventor: Lien-Sheng CHANG, Feng Yuan (TW)

(21) Appl. No.: 12/701,794

(22) Filed: Feb. 8, 2010

(51) Int. Cl. H01T 13/04

(52) U.S. Cl. 313/135

(57) ABSTRACT

A spark plug for a model engine includes a main body. The main body has a through hole at a central portion thereof and an engaging portion disposed at a first end of the through hole to position a central electrode. The central electrode includes a connection portion at one end thereof and an extension portion at an opposing end thereof. The connection portion is protruded from the first end of the through hole. The extension portion is axially disposed in the through hole and connected with an ignition coil. One part of the through hole of the main body, close to the extension portion, is gradually enlarged towards a second end of the through hole to form an enlarged opening. The gas in the enlarged opening can be burned in an enlarged way and diffused in the cylinder of the model engine entirely, providing a complete combustion effect to enhance the horsepower of the model engine and stabilize the idle speed.

### BACKGROUND OF THE INVENTION

1. Field of the Invention

The present invention relates to the structure of a spark plug, and more particularly to a spark plug for a model engine.

2. Description of the Prior Art

As shown in FIG. 1, a conventional spark plug comprises a main body 1. The main body 1 has a through hole 2 at a central portion thereof and a recess 3 disposed at one end of the through hole 2 to accommodate a central electrode 4. The recess 3 has a diameter larger than that of the through hole 2. The central electrode 4 includes a connection portion 5 at one end thereof and an extension portion 6 at an opposing end thereof. The connection portion 5 is protruded from the through hole 2. The extension portion 6 is axially disposed in the through hole 2. The main body 1 comprises an ignition coil 7 therein which is located opposite the recess 3. One end of the ignition coil 7 is connected to the extension portion 6 of the central electrode 4, and another end of the ignition coil 7 is connected to the main body 1. As shown in FIG. 2, when in use, the conventional spark plug is mounted on a cylinder 8 of a model engine. The model engine is electrified to heat the ignition coil 7 for igniting the gas in the cylinder 8 to move a piston 9 in the model engine to start operation. However, the ignition coil 7 of the conventional spark plug is located in the through hole 2. The through hole 2 is arranged in a straight form. When the ignition coil 7 ignites the gas in the through hole 2, the flame will go toward the piston 9 along the inner wall of the through hole 2. The flame cannot be diffused in the cylinder 8 entirely, resulting in incomplete combustion of the gas in the cylinder 8, such that the idle speed of the model engine is unstable and the accelerated speed is rising and falling.

### SUMMARY OF THE INVENTION

The present invention is to provide a spark plug for a model engine. The spark plug includes a main body. The main body has a through hole at a central portion thereof and an engaging portion disposed at a first end of the through hole to position a central electrode. The central electrode includes a connection portion at one end thereof and an extension portion at an opposing end thereof. The connection portion is protruded from the first end of the through hole. The extension portion is axially disposed in the through hole and connected with an ignition coil. One part of the through hole of the main body, close to the extension portion, is gradually enlarged towards a second end of the through hole to form an enlarged opening. The gas in the enlarged opening can be burned in an enlarged way and diffused in the cylinder of the model engine entirely, providing a complete combustion effect. The present invention not only enhances the combustion efficiency but also stabilizes the idle speed and the accelerated speed of the model engine. The spark plug of the present invention can increase 5% to 7% of the horsepower of the model engine and provide gas-saving and environmental friendly effects.

### BRIEF DESCRIPTION OF THE DRAWINGS

FIG. 1 is a cross-sectional view of a conventional spark plug;

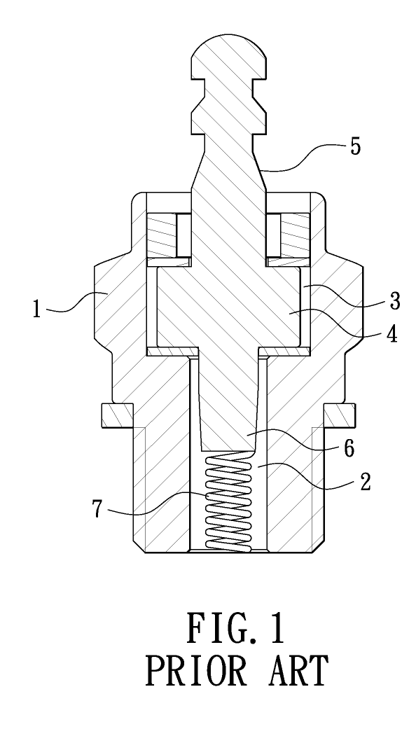

FIG. 2 is a schematic view of the conventional spark plug when in use;

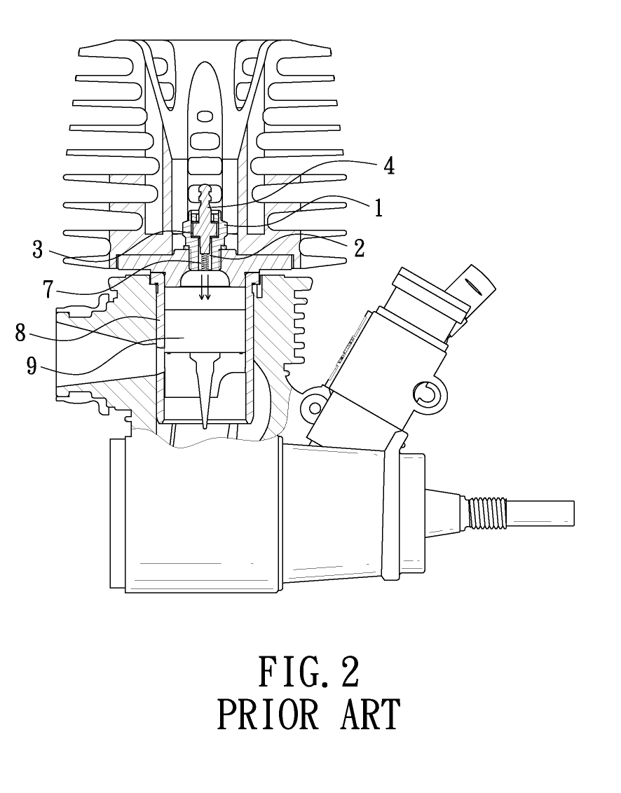

FIG. 3 is a cross-sectional view according to a preferred embodiment of the present invention; and

FIG. 4 is a schematic view according to the preferred embodiment of the present invention when in use.

### DETAILED DESCRIPTION OF THE PREFERRED EMBODIMENTS

Embodiments of the present invention will now be described, by way of example only, with reference to the accompanying drawings.

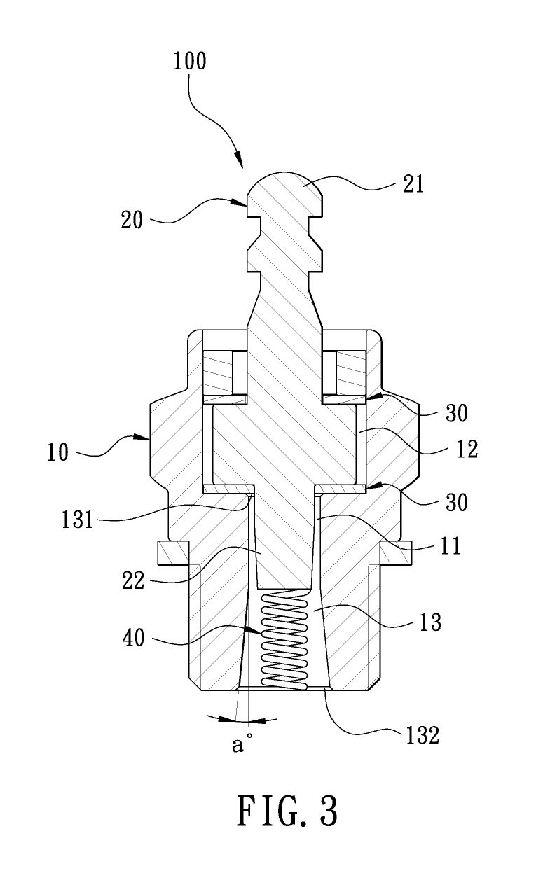

As shown in FIG. 3, a spark plug 100 for a model engine according to a preferred embodiment of the present invention comprises a main body 10. The main body 10 has a through hole 11 at a central portion thereof and an engaging portion 12 disposed at a first end of the through hole 11. In this embodiment, the engaging portion 12 is a recess which has a diameter larger than that of the through hole 11 for positioning a central electrode 20. The central electrode 20 includes two insulation washers 30 at two sides thereof to insulate against the main body 10, a connection portion 21 at one end thereof, and an extension portion 22 at an opposing end thereof. The connection portion 21 is protruded from the first end of the through hole 11, and the extension portion 22 is axially disposed in the through hole 11. One part of the through hole 11 of the main body 10, close to the extension portion 22, is gradually enlarged towards a second end of the through hole 11 to form an enlarged opening 13. An included angle in the range of 5 degrees to 15 degrees is defined between an inner wall of the enlarged opening 13 and a central axis of the enlarged opening 13. The enlarged opening 13 has two ends which are defined as a small end 131 and a large end 132, respectively. The small end 131 is flush with a distal end of the extension portion 22 of the central electrode 20. The spark plug 100 further comprises an ignition coil 40 therein. The ignition coil 40 is made of platinum material in a spiral form. The ignition coil 40 has one end connected to the distal end of the extension portion 22 and another end connected to the large end 132 of the enlarged opening 13.

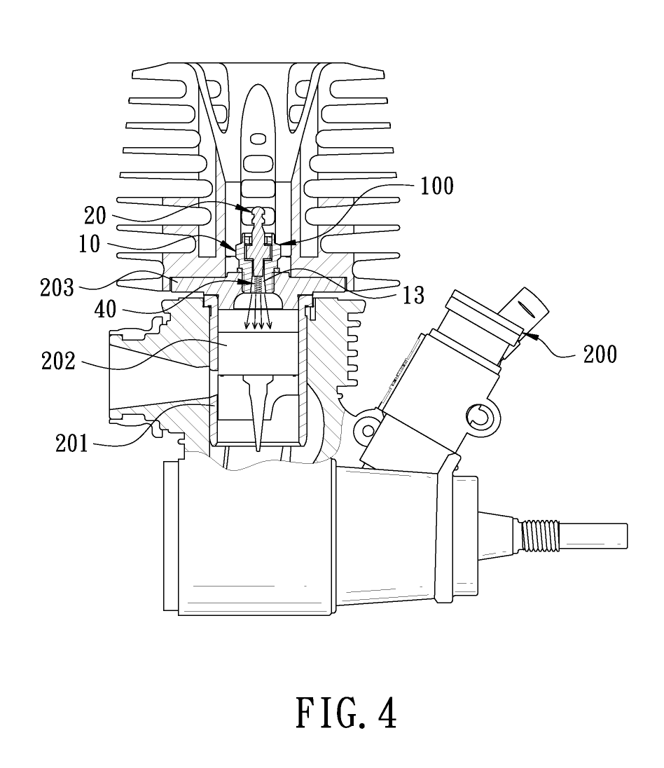

As shown in FIG. 4, when in use, the spark plug 100 is mounted on a model engine 200. The model engine 200 comprises a cylinder 201, a piston 202 in the cylinder 201, and a cylinder cap 203 on the cylinder 201 to lock the spark plug 100. To start the model engine 200, the ignition system (not shown in the drawings) of the model engine 200 is connected with the connection portion 21 of the central electrode 20 and electrified to heat the ignition coil 40. When the temperature of the ignition coil 40 rises to a preset value, the fuel gas poured in the cylinder 201 in advance will be diffused in the cylinder 201 entirely. Because the ignition coil 40 is located in the enlarged opening 13, the gas will be ignited in the enlarged opening 13 and the flame will go towards the piston 202 along the inner wall of the enlarged opening 13 to fill the cylinder 201 entirely, providing a complete combustion of the gas in the cylinder 201 so as to move the piston 202 downward. The present invention not only enhances the combustion efficiency but also stabilizes the idle speed and the accelerated speed of the model engine 200. After a test, the spark plug 100 of the present invention can increase 5% to 7% of the horsepower of the model engine 200. Besides, the gas is burned completely to decrease the carbon accumulated in the model engine 200, providing gas-saving and environmental friendly effects.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A spark plug for a model engine, comprising a main body, the main body having a through hole at a central portion thereof and an engaging portion disposed at a first end of the through hole to position a central electrode, the central electrode including a connection portion at one end thereof and an extension portion at an opposing end thereof, the connection portion being protruded from the first end of the through hole, the extension portion being axially disposed in the through hole and connected with an ignition coil, and characterized by that:
one part of the through hole of the main body, close to the extension portion, being gradually enlarged towards a second end of the through hole to form an enlarged opening.

2. The spark plug as claimed in claim 1, wherein an included angle in the range of 5 degrees to 15 degrees is defined between an inner wall of the enlarged opening and a central axis of the enlarged opening.

3. The spark plug as claimed in claim 1, wherein the enlarged opening has two ends defined as a small end and a large end, respectively, and the small end is flush with a distal end of the extension portion of the central electrode.
